(19) United States
(12) Patent Application Publication
(10) Pub. No.: US 2016/0040474 A1
(43) Pub. Date: Feb. 11, 2016

(54) Pivot-Slide Doors and Windows

(71) Applicant: Bin Geng, Burnaby (CA)

(72) Inventor: Bin Geng, Burnaby (CA)

(21) Appl. No.: 14/454,896

(22) Filed: Aug. 8, 2014

(51) Int. Cl. E06B 3/50; E06B 1/52; E06B 1/36

(52) U.S. Cl. CPC E06B 3/5054; E06B 1/36; E06B 1/52; E06B 3/5072

(57) ABSTRACT

A multi-panel pivot-slide door or window structure is disclosed. The door assembly includes multiple door panels mounted on one guide rail/track of the head and sill, which are connected with two jambs to form door rim/frame opening. A pivot-wheel mechanism is configured on each of the door panels in which each panel is operable to pivot to open and then slide to either side to maximize the open area of the opening.

### DESCRIPTION OF RELATED ART

The present application relates to a new type of door or window, of which each panel assembly can pivot to open independently and then can slide to either left or right side.

Note that the points discussed below may reflect the hindsight gained from the disclosed inventions, and are not necessarily admitted to be prior art.

Building energy efficiency requirement requires high quality and better performing door and window products. More and more architectural buildings either residential or commercial are also looking for friendly designs of windows and doors that offer space flexibility. Multi-panel door and window designs have been the favorite choices by many building architects, for their ease of operation and adaption to different size requirements.

Driven by insatiable and constant changing human desires in improving their living condition and aesthetic looks of their homes, improvement of windows and doors in exterior look and feel, in the grace of operation has always been desired.

There is always a need for novel and original designs of doors and windows such as door or windows enabling broader and wider openings, where each panel is operated individually, multiple sliding panels operate on one single dimensional layer.

### SUMMARY

The present application discloses new multi-panel door or window design that allows each individual panel to pivot and then slide independently.

In one embodiment, the door assembly includes multiple door panels mounted on one guide rail/track of the head and sill that are connected with two jambs to form door rim/frame opening. The width of whole door opening may be unlimited in length. Each panel is operable to pivot to open and then slide to either side to maximize the open area of the opening.

In one aspect of the embodiment each operable door panel is independent and it can be operated individually, in contrast to folding doors in which the panels are connected and related.

In one aspect of the embodiment the axis of pivot of each operable door panel is moveable along the track/guide rail, in contrast to conventional pivot door where the axis of pivot is immobile.

In one aspect of the embodiment every panels sliding on same track/guide rail and stay in one same single layer on the same guide rail track when the panels are closed, in contrast to the conventional sliding door where the each slider are on different tracks/guide rail or layers.

In one embodiment, a pivot axis mechanism and sliding wheel component is configured to hold an individual door panel on both the top and bottom guide rails/tracks, enabling the door to spin open and then slide on the track. This configuration makes the pivot axis of each door panel movable, slide on the track.

In one embodiment, an operated bar mechanism is configured on both top and the bottom horizontal components of door panel to lock and seal a door panel horizontally when the panel is closed.

The disclosed innovation, in various embodiments, provides one or more of at least the following advantages, that each panel in the assembly can be independently operable, can gracefully pivot to open and then slide either to the left or to the right. All panels stay in the same guide rail track and same layer, providing an integrated simplicity to the look and feel of the door or window. All panels can be pushed to slide together to allow for maximum opening space, offering an elegant grace of seamless assembly and smooth operation.

However, not all of these advantages result from every one of the innovations disclosed, and this list of advantages does not limit the various claimed inventions.

### BRIEF DESCRIPTION OF THE DRAWINGS

The disclosed application will be described with reference to the accompanying drawings, which show example embodiments of the invention and which are incorporated in the specification hereof by reference, wherein:

FIG. 1A is a perspective view of an example door or window assembly at closed in accordance with this application.

FIG. 1B is a perspective view of an example door or window assembly with one door panel pivoted open in accordance with this application.

FIG. 1C is a perspective view of an example door or window assembly with one door panel open and sliding in accordance with this application.

FIG. 1D is a perspective view of an example door or window assembly with multiple door panels open and sliding in accordance with this application.

FIGS. 2A and 2B show an example door track frame assembly in accordance with this application.

FIG. 2C shows an example process of assembling an example door panel in accordance with this application.

FIG. 3A shows a side sectional view of the top axis mechanism and sliding wheel component of an example door panel in accordance with this application.

FIG. 3B shows a side sectional view of the bottom axis mechanism and sliding wheel component of an example door panel in accordance with this application.

FIGS. 3C and 3D respectively shows a side sectional view of an assembled top and bottom axis mechanisms and sliding wheel components of an example door panel in accordance with this application.

FIG. 3E shows a side sectional view of an assembled example door panel after pivoting in accordance with this application.

FIGS. 4A and 4B respectively shows a perspective view of an assembled top and bottom sections of an example door panel with respect to a door track frame in accordance with this application.

FIGS. 4C and 4D respectively shows a perspective view of the top and bottom rotation mechanism of an example door panel in relation to the door track frame in accordance with this application.

FIGS. 5A, 5B and 5C respectively shows sectional view of the locking process of a door panel on a door track frame in accordance with this application.

FIGS. 6A, 6B, and 6C respectively shows perspective view of the locking and releasing and rotating process of a door panel on a door track frame in accordance with this application.

FIG. 7A-7H, FIG. 8A-8H and FIG. 9A-9H respectively shows perspective views and top side views of an example door or window at alternative opening options in accordance with this application.

### DETAILED DESCRIPTION OF SAMPLE EMBODIMENTS

The numerous innovative teachings of the present application will be described with particular reference to presently preferred embodiments (by way of example, and not of limitation). The present application describes several embodiments, and none of the statements below should be taken as limiting the claims generally.

For simplicity and clarity of illustration, the drawing figures illustrate the general manner of construction, and description and details of well-known features and techniques may be omitted to avoid unnecessarily obscuring the invention. Additionally, elements in the drawing figures are not necessarily drawn to scale, some areas or elements may be expanded to help improve understanding of embodiments of the invention.

The terms “first,” “second,” “third,” “fourth,” and the like in the description and the claims, if any, may be used for distinguishing between similar elements and not necessarily for describing a particular sequential or chronological order. It is to be understood that the terms so used are interchangeable. Furthermore, the terms “comprise,” “include,” “have,” and any variations thereof, are intended to cover non-exclusive inclusions, such that a process, method, article, apparatus, or composition that comprises a list of elements is not necessarily limited to those elements, but may include other elements not expressly listed or inherent to such process, method, article, apparatus, or composition.

It is contemplated and intended that the designs and their equivalents presented herein apply to doors and windows made of any suitable materials; for clarity reason, the examples may be given based on metal or wood or plastic materials, but an ordinary person in the art would know the variations to modify the designs.

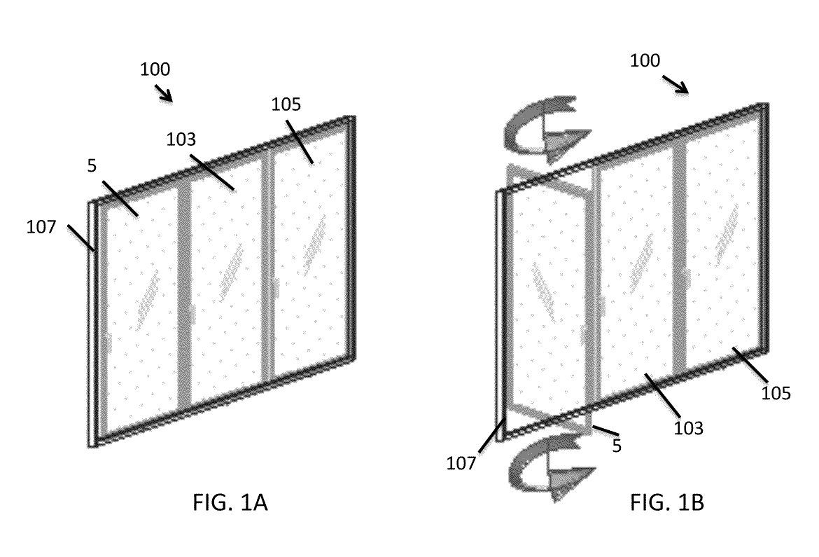

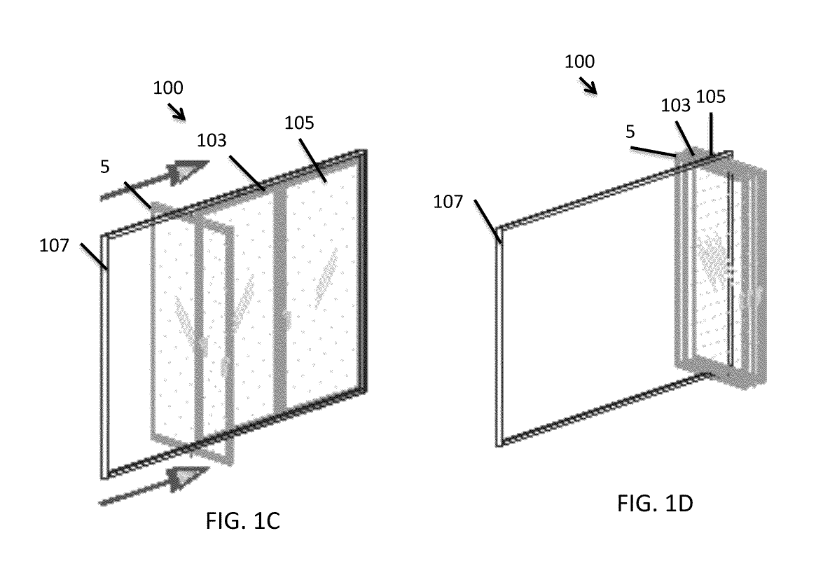

FIG. 1A shows an example multiple panel door or window 100 in closed condition. Multiple panel door or window 100 includes a frame 107 and three pivotal panels 5, 103, and 105 wherein the three door panels are slidingly amounted on frame 107. After unlocking, each panel is free to rotate and slide on the frame rail as shown in FIGS. 1B, 1C and 1D, maximizing the opening space of the door/window 100 (FIG. 1D).

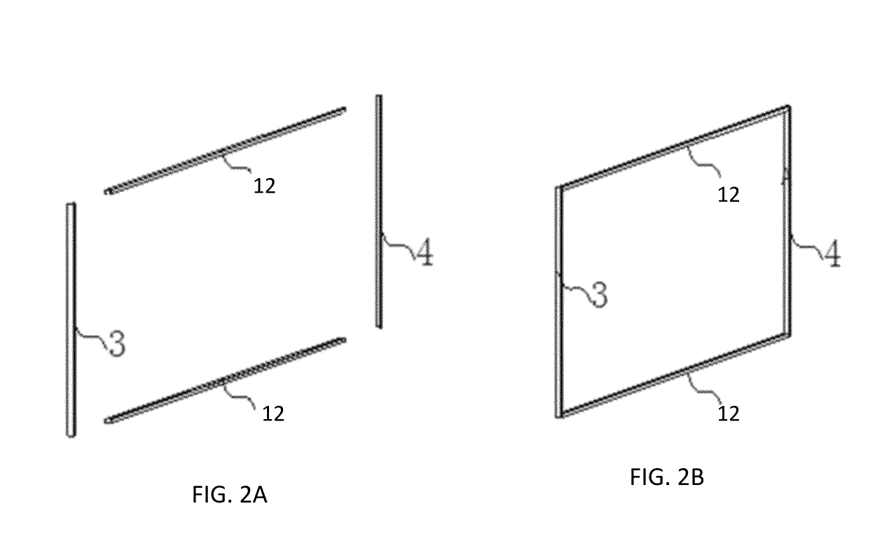

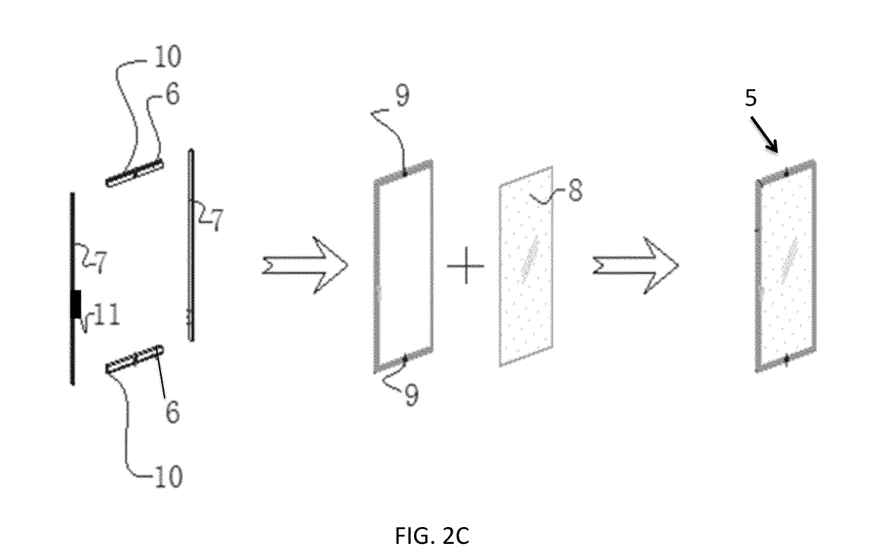

In reference to FIG. 2A, frame 107 comprises horizontal head 12, sill 12 and two vertical jambs 3 and 4 which are assembled together through the conventional frame mechanism as shown in FIG. 2B. The two horizontal bars 12 as head and sill functioning as the guide rails/tracks for the panels, and are joined together with two vertical jambs 3 and 4 to form a pivot-slide door rim.

In reference to FIG. 2C, an example pivot-slide operable door panel 5 shown in FIG. 1A is assembled together with two horizontal components 6 and two vertical stile or mullions 7 and a glazing single, double, triple glazing or other filling panel materials 8. A handle structure 11 is attached on million 7. Horizontal components 6 are configured with two grooves, one for holding panel material 8 with conventional design and structure, the other for holding a locking mechanism and a pivot mechanism.

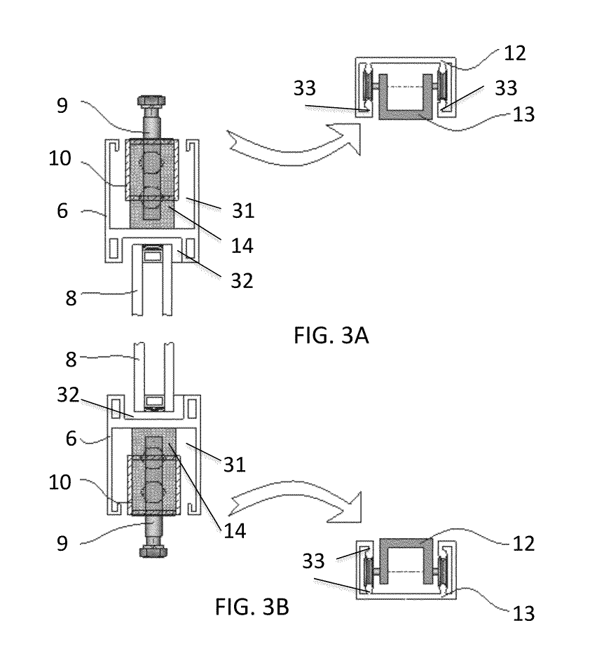

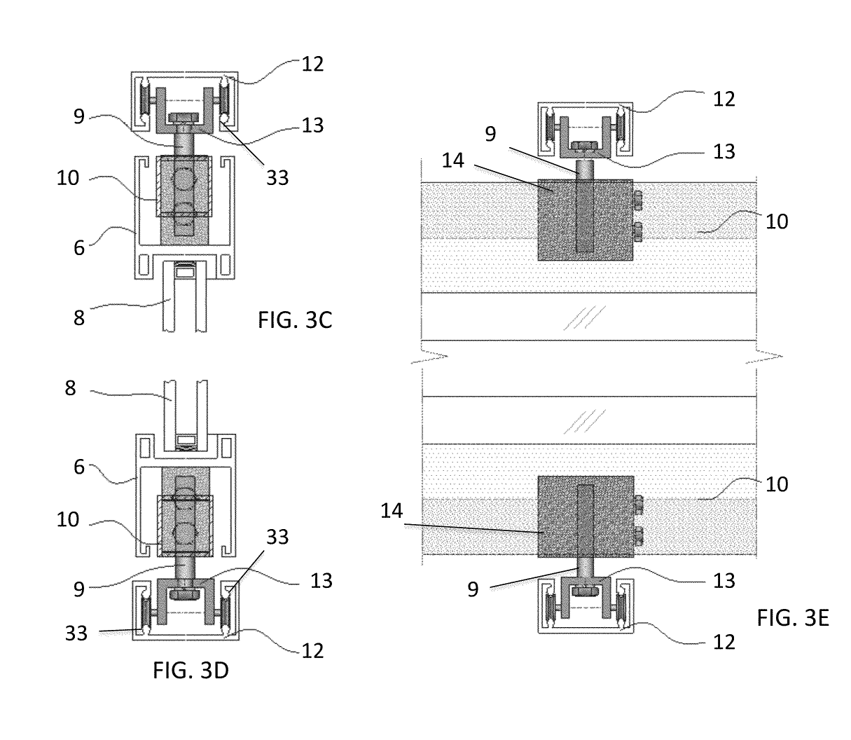

In reference to FIGS. 3A and 3B, horizontal component 6 is designed with two holding grooves 31 and 32, groove 32 for holding glass panel 8 and groove 31 for holding an operable bar 10 and a pivot mechanism seat 14. Mounted inside groove 31 is an operated bar 10, and handle 11 is configured to operate and control bars 10 to move either inside or outside of the horizontal components 6 for locking and sealing the door panel horizontally in place. Two pivot axis structures 9 and their rotating seating mechanisms 14 (FIG. 3A) are fixedly mounted onto their respective horizontal components 6, anywhere along the horizontal length of components 6, which function as an anchor pivot of the door panel to the upper and lower track rail 12 to allow the entire door panel to rotate around axis 9. The track rail 12 is preferably configured to be in U shape with inwardly bending rails 33 for holding a wheel component 13 such that the wheels of component 13 can smoothly slide on rails 33 in the space between rail 33 and the bottom track wall of 12 without falling off. The shape and width of track rail 12 matches to the shape and width of groove 31 of horizontal component 6, both of them are configured to allow operate bar 10 slide in and out vertically. Operable bar 10 is preferably an elongated or cubic tube bar smaller in size and length to the holding groove 31 of horizontal component 6, having sufficient height to bridge the space gap between track 12 and horizontal component 6. There may be built in rails 33 on the top or bottom walls of track 12 to securely hold the wheels of wheel component 13.

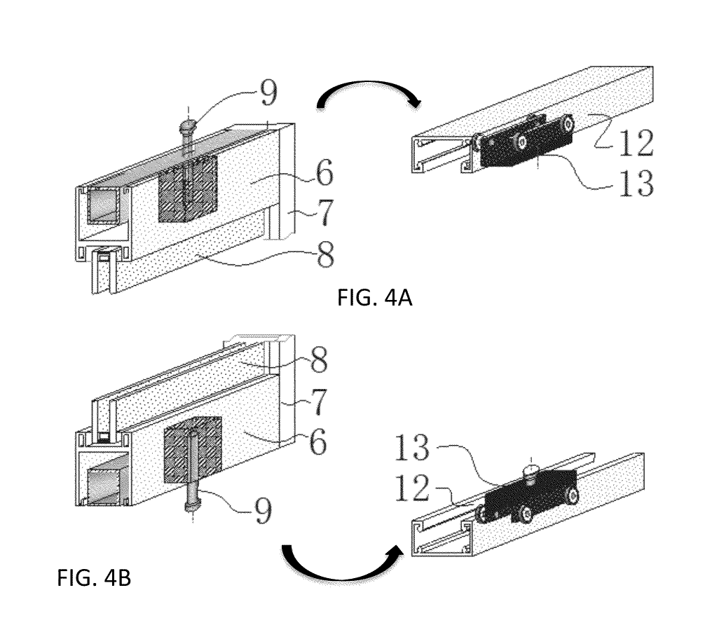

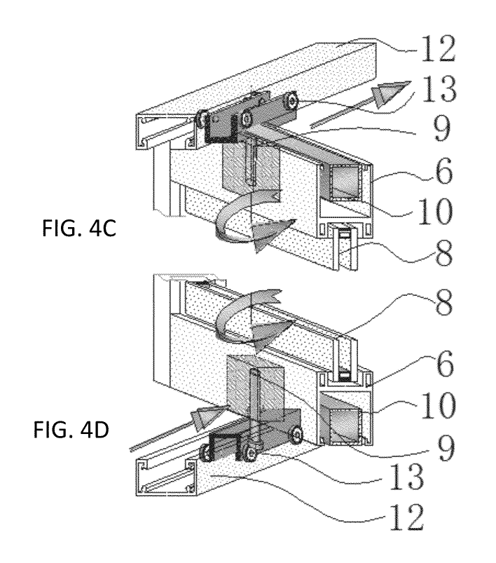

In reference to FIGS. 3C, 3D and 3E, pivot axis 9 is rotatedly amounted on a holding seat 14 which in turn is located inside the holding groove of the horizontal component 6, allowing door panel 5 to pivot. The structure of pivot axis 9 and its holding seat 14 are any kind, the particular designs are conventionally known and commercially available. Wheel component 13 which is physically connected with pivot axis 9 (FIG. 3C and 3D) allows the door panel slide via the wheels of wheel component 13 along the head and sill guide rail/track 12. The pivot axis mechanism 9 and 14 can be located at anywhere of width of door panel per architectural design. FIG. 3E shows a sectional view of the rotated door panel. For clarity, FIGS. 4A, 4B, 4C, and 4D show the respective perspective views of the interactions of the components in three dimensions.

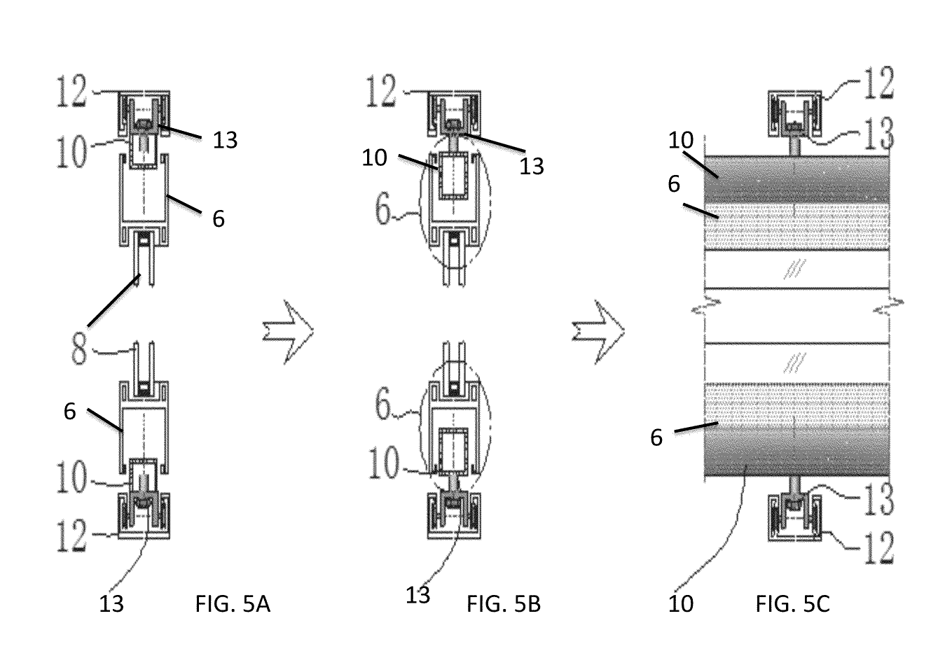

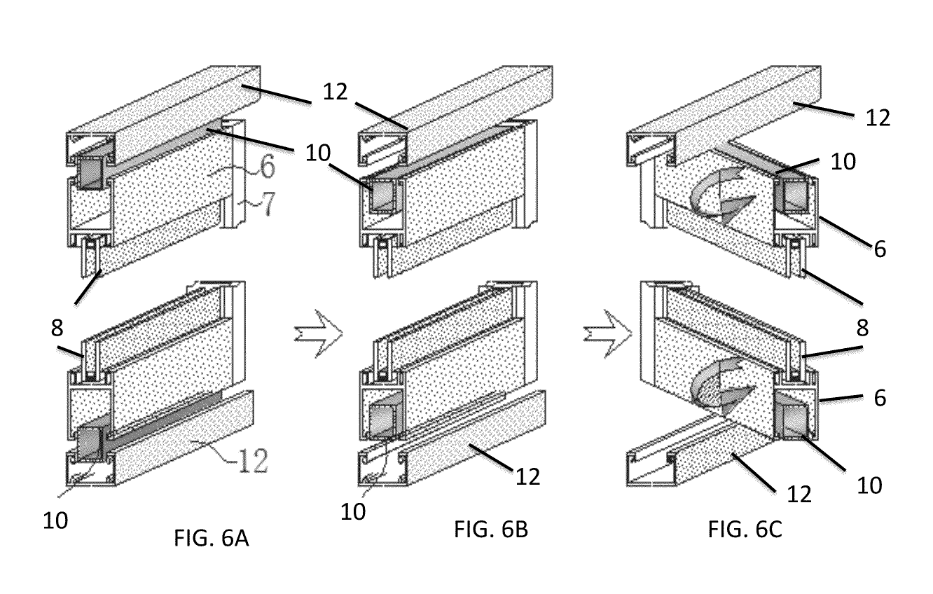

In reference to FIGS. 5A, 5B and 5C, a detailed locking mechanism is illustrated. Elongated cubic bar 10 is operable to move out of the holding groove 31 of horizontal component 6 of the door panel and partially move into the U shape of track rail 12 (FIG. 5A), bridging the gap between track 12 and horizontal component 6, thus effectively preventing the door panel from rotating around axis 9, locking and sealing the door panel horizontally. When operable bar 10 is operated to full move out of track 12 and move into the holding groove 31 of horizontal component 6, (FIG. 5B), the door panel is free to rotate around axis 9 to an open position (FIG. 5C, FIG. 4C and 4D), allowing the door panel to slide on track 12 via wheels of wheel component 13. FIG. 5C shows a sectional view of the rotated door panel. For clarity, FIGS. 6A, 6B, and 6C show the respective perspective views of interactions of operable bar 10 with track rails 12 and horizontal components 6 of the door panel in three dimensions.

In the examples shown in the figures, operable bar 10 is shown to be an elongated cubic tube-like bar in about the same length to the horizontal component 6. Operable bar 10 may be configured in other shapes and other sizes as long as it has sufficient height and strength to bridge the space gap between track 12 and horizontal component 6, to seal the door panel horizontally, and sufficient small dimension to move in and out of both of the grooves of track 12 and horizontal component 6.

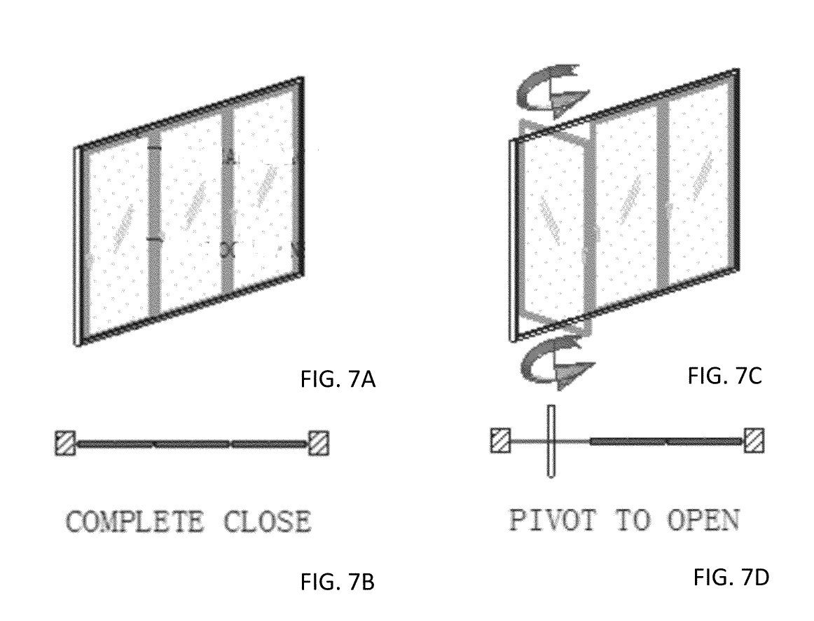

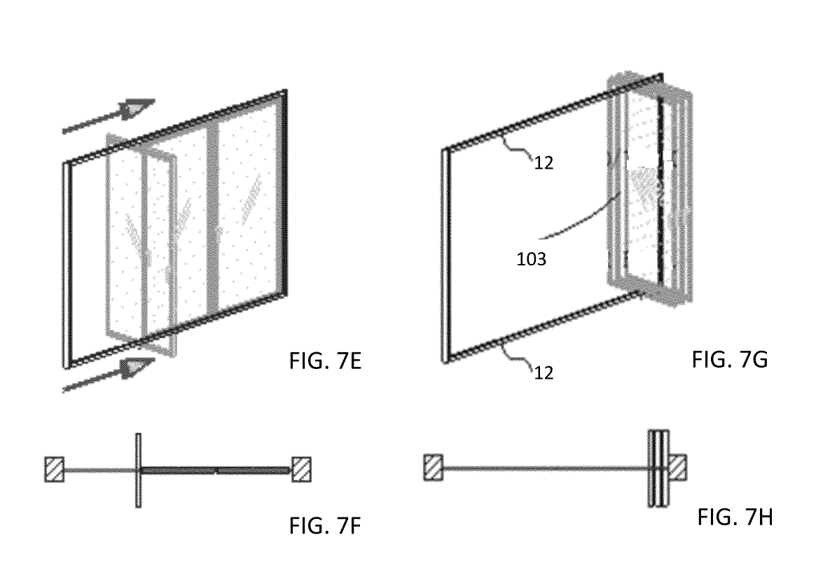

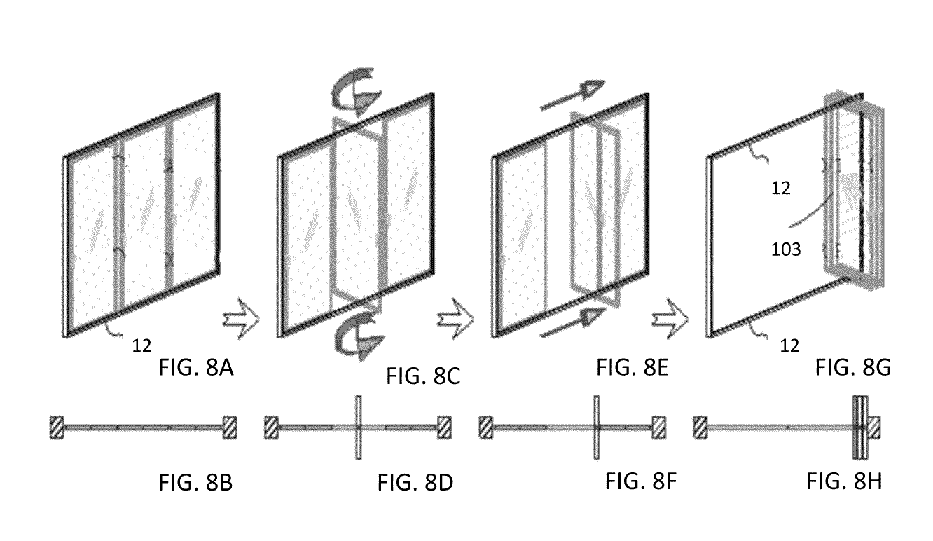

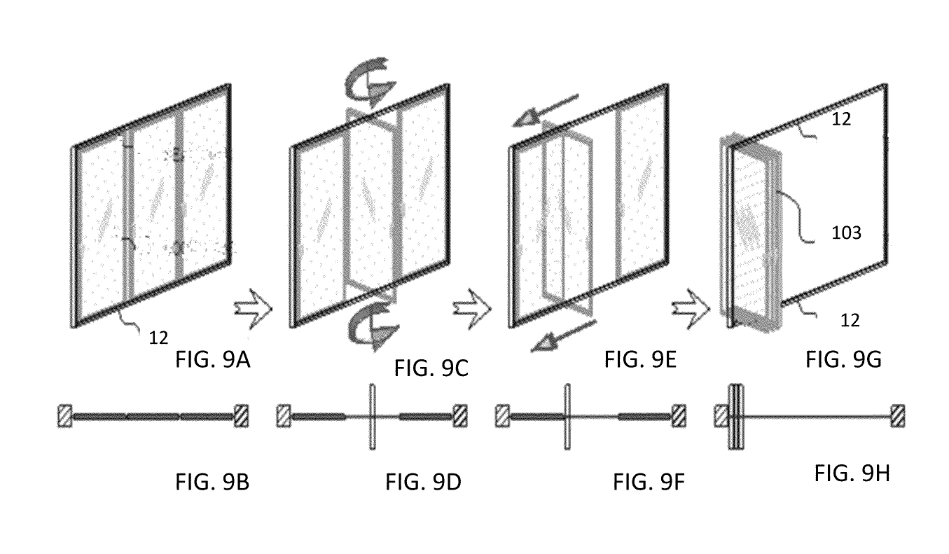

FIG. 7A-7H, FIG. 8A-8H, FIG. 9A-9H respectively show perspective views and top side views of an example door at alternative opening options in accordance with this application.

As will be recognized by those skilled in the art, the innovative concepts described in the present application can be modified and varied over a tremendous range of applications, and accordingly the scope of patented subject matter is not limited by any of the specific exemplary teachings given. It is intended to embrace all such alternatives, modifications and variations that fall within the spirit and broad scope of the appended claims.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

The claims as filed are intended to be as comprehensive as possible, and NO subject matter is intentionally relinquished, dedicated, or abandoned.

What is claimed is:

1. A pivot-slide door or window, comprising:
a door or window panel;
a guide rail track frame having horizontal guide rails;
a wheel assembly having a pair of wheels, said pair of wheels are disposed on said horizontal guide rails to slide horizontally;
a pivot mechanism having a pivot axis and a seating structure, the pivot axis being rotatably mounted on said wheel assembly; and
a horizontal component having a first and second holding grooves, wherein the first holding groove is configured to fixedly hold the door or window panel in vertical position, and the second holding groove is configured to fixedly hold the seating structure of said pivot mechanism,
thereby the door or window panel is enabled to pivot round said pivot axis and slide on said horizontal guide rails.

2. The pivot-slide door or window of claim 1, wherein said horizontal component further comprises:
an operable bar movably mounted within the second groove of said horizontal component, being configured to be controlled by a handle to move partially into said horizontal guide rails and bridge between said horizontal component and said head rail track frame, thereby lock the door or window panel.

3. The pivot-slide door or window of claim 2, wherein said operable bar is configured in sufficient dimension to move in and out of both of the grooves of said horizontal guide rail and horizontal component, and sufficient height and strength to bridge between said horizontal guide rails and horizontal component to lock and seal the door panel horizontally.

4. The pivot-slide door or window of claim 1, wherein said horizontal guide rails are formed by a U-shapely dimensioned elongated rim.

5. The pivot-slide door or window of claim 1, wherein said horizontal guide rails are extendable with additional guide rails.

6. A pivot-slide door or window, comprising:
a guide rail track frame having a pair of horizontal guide rails;
a plurality of door or window panels;
a plurality of wheel assemblies having a pair of wheels, said each pair of wheels are respectively disposed on said horizontal guide rails to slide horizontally;
a plurality of pivot mechanisms, each having a pivot axis and a seating structure, the pivot axis being rotatably mounted on a respective one of said plurality of wheel assemblies; and
a plurality of horizontal components, each having a first and second holding grooves, wherein the first holding groove is configured to fixedly hold one of the plurality of the door or window panels in vertical position, and the second holding groove is configured to fixedly hold the seating structure of one of the plurality of said pivot mechanisms,
thereby said plurality of door or window panels are individually and independently enabled to pivot round respective said pivot axis and slide on said pair of horizontal guide rails in one layer.

7. The pivot-slide door or window of claim 6, wherein at least one of said horizontal components further comprises:
an operable bar movably mounted within the second groove of said horizontal component, being configured to be controlled by a handle to move partially into said horizontal guide rails and bridge between said horizontal component and said head rail track frame, thereby lock the door or window panel.

8. The pivot-slide door or window of claim 7, wherein said operable bar is configured in sufficient dimension to move in and out of both of the grooves of said horizontal guide rail and horizontal component, and sufficient height and strength to bridge between said horizontal guide rails and horizontal component to lock and seal the door panel horizontally.

9. The pivot-slide door or window of claim 6, wherein said horizontal guide rails are formed by a U-shapely dimensioned elongated rim.

10. The pivot-slide door or window of claim 6, wherein said horizontal guide rails are extendable with additional guide rails.
